(19) United States
(12) Patent Application Publication
(10) Pub. No.: US 2011/0063762 A1
(43) Pub. Date: Mar. 17, 2011

(54) FLASH MEMORY CIRCUIT WITH ESD PROTECTION

(76) Inventors: Tang-Lung Lee, Taipei County (TW); Shao-Chang Huang, Hsinchu City (TW); Wei-Yao Lin, Hsinchu County (TW); Kun-Wei Chang, Taipei County (TW)

(21) Appl. No.: 12/558,571

(22) Filed: Sep. 13, 2009

(51) Int. Cl. H02H 9/00

(52) U.S. Cl. 361/56

(57) ABSTRACT

A flash memory circuit with ESD protection includes a plurality of flash memory blocks, a pad, an ESD transistor, a pass transistor, and a gate driving circuit. The gate driving circuit has an inverter circuit for receiving a control voltage and outputting an output voltage, a resistor for receiving a pad voltage from the pad, and a capacitor for delaying a change in the control voltage. The ESD transistor is coupled to the pad, a power supply, and the output terminal of the inverter circuit. The pass transistor is coupled to one of the flash memory blocks and the pad, and is controlled by the output voltage. A well terminal of the pass transistor is coupled to the resistor for keeping the pass transistor turned off during electrostatic discharge through the pad.

### BACKGROUND OF THE INVENTION

1. Field of the Invention

The present invention relates to ESD protection circuits for flash memory, and more particularly, to a flash memory circuit with ESD protection having an enhanced N-well controlled protection mechanism.

2. Description of the Prior Art

Flash memory is a type of non-volatile memory commonly employed in memory cards, flash drives, and portable electronics for providing data storage and transfer. Flash memory may be electrically written to, erased, and reprogrammed to allow deletion of data and writing of new data. Some advantages of flash memory include fast read access time, and shock resistance. Flash memory is also very resistant to pressure and temperature variations.

Please refer to FIG. 1, which is a diagram of a flash memory circuit 10. The flash memory circuit 10 includes a plurality of flash memory blocks 100 that are programmable through a programming voltage VPP applied at a pad VPP_PAD. A gate driving circuit 110 drives a gate terminal of a pass gate 130 to allow the programming voltage VPP to be sent to the flash memory blocks 100. When the programming voltage VPP is applied at the pad VPP_PAD, a first transistor MN is turned on to pull down voltage applied to the gate terminal of the pass gate 130. Thus, the pass gate 130 turns on, and the programming voltage VPP may be sent to the flash memory blocks 100.

Please refer to FIG. 2. Electrostatic discharge (ESD) entering the flash memory circuit 10 through the pad VPP_PAD is one potential source of damage to the flash memory blocks 100. To mitigate the ESD effect, one goal is to direct excess charges to a lower potential node, such as a node VSS. The flash memory circuit 10 thus further comprises an ESD transistor M_ESD for redirecting ESD current away from the flash memory blocks 100. When the voltage applied to the pad VPP_PAD goes high, a gate terminal of the ESD transistor M_ESD is temporarily pulled high at a node G1 through the second transistor MP, because a MOS capacitor NC and a resistor R keep gates of the first transistor MN and the second transistor MP low while the MOS capacitor NC is charged by the ESD charges. ESD zapping typically occurs for a period on the order of nanoseconds. Thus, the resistor R and the MOS capacitor NC may be designed with a RC time constant of approximately lus to keep the ESD transistor M_ESD turned on long enough to redirect most or all of the ESD current. However, if the voltage of the gate terminal G1 of the ESD transistor M_ESD cannot reach the programming voltage VPP_PAD in time, ESD charges may enter the flash memory blocks 100. This is because the pass gate 130 may turn on due to N-well voltage being higher than the voltage at the node G1 (a bulk terminal of the pass gate 130 directly receives the voltage applied to the pad VPP_PAD).

### SUMMARY OF THE INVENTION

According to a first embodiment of the present invention, a flash memory circuit comprises a plurality of flash memory blocks, a pad for receiving a pad voltage, an ESD transistor, a pass transistor, and a gate driving circuit. The gate driving circuit comprises an inverter circuit, a resistor, and a capacitor. The inverter has an input terminal for receiving a control voltage, and an output terminal for outputting an output voltage. The inverter circuit inverts the control voltage to generate the output voltage. The resistor is for receiving the pad voltage, and comprises a first terminal coupled to the pad, and a second terminal coupled to the input terminal of the inverter circuit. The capacitor is for delaying a change in the control voltage, and comprises a first terminal coupled to the input terminal of the inverter circuit, and a second terminal coupled to a power supply. The ESD transistor comprises a first terminal coupled to the pad, a second terminal coupled to the power supply, and a control terminal coupled to the output terminal of the inverter circuit for receiving the output voltage, and controlling conduction of current from the first terminal of the ESD transistor to the second terminal of the ESD transistor according to the output voltage. The pass transistor comprises a first terminal coupled to one of the flash memory blocks, a second terminal coupled to the pad, and a control terminal coupled to the output terminal of the inverter circuit for receiving the output voltage, and controlling conduction of current from the first terminal of the pass transistor to the second terminal of the pass transistor according to the output voltage. A well terminal of the pass transistor is coupled to the second terminal of the resistor for keeping the pass transistor turned off during electrostatic discharge through the pad.

According to a second embodiment of the present invention, a flash memory circuit comprises a plurality of flash memory blocks, a pad for receiving a pad voltage, an ESD transistor, a pass transistor, and a gate driving circuit. The gate driving circuit comprises an inverter circuit, a first resistor, a second resistor, and a capacitor. The inverter has an input terminal for receiving a control voltage, and an output terminal for outputting an output voltage. The inverter circuit inverts the control voltage to generate the output voltage. The first resistor is for receiving the pad voltage, and comprises a first terminal coupled to the pad, and a second terminal. The second resistor comprises a first terminal coupled to the second terminal of the first resistor, and a second terminal coupled to the input terminal of the inverter circuit. The capacitor is for delaying a change in the control voltage, and comprises a first terminal coupled to the input terminal of the inverter circuit, and a second terminal coupled to a power supply. The ESD transistor comprises a first terminal coupled to the pad, a second terminal coupled to the power supply, and a control terminal coupled to the output terminal of the inverter circuit for receiving the output voltage, and controlling conduction of current from the first terminal of the ESD transistor to the second terminal of the ESD transistor according to the output voltage. The pass transistor comprises a first terminal coupled to one of the flash memory blocks, a second terminal coupled to the pad, and a control terminal coupled to the output terminal of the inverter circuit for receiving the output voltage, and controlling conduction of current from the first terminal of the pass transistor to the second terminal of the pass transistor according to the output voltage. A well terminal of the pass transistor is coupled to the second terminal of the first resistor for keeping the pass transistor turned off during electrostatic discharge through the pad.

According to a third embodiment of the present invention, a flash memory circuit comprises a plurality of flash memory blocks, a pad for receiving a pad voltage, an ESD transistor, a pass transistor, and a gate driving circuit. The gate driving circuit comprises an inverter circuit, a first resistor, a second resistor, a first capacitor, and a second capacitor. The inverter has an input terminal for receiving a control voltage, and an output terminal for outputting an output voltage. The inverter circuit inverts the control voltage to generate the output voltage. The first resistor is for receiving the pad voltage, and comprises a first terminal coupled to the pad, and a second terminal coupled to the input terminal of the inverter circuit. The first capacitor is for delaying a change in the control voltage, and comprises a first terminal coupled to the input terminal of the inverter circuit, and a second terminal coupled to a power supply. The second resistor is for receiving the pad voltage, and comprises a first terminal coupled to the pad, and a second terminal for outputting a well control voltage. The second capacitor is for delaying a change in the well control voltage, and comprises a first terminal coupled to the second terminal of the second resistor, and a second terminal coupled to the power supply. The ESD transistor comprises a first terminal coupled to the pad, a second terminal coupled to the power supply, and a control terminal coupled to the output terminal of the inverter circuit for receiving the output voltage, and controlling conduction of current from the first terminal of the ESD transistor to the second terminal of the ESD transistor according to the output voltage. The pass transistor comprises a first terminal coupled to one of the flash memory blocks, a second terminal coupled to the pad, and a control terminal coupled to the output terminal of the inverter circuit for receiving the output voltage, and controlling conduction of current from the first terminal of the pass transistor to the second terminal of the pass transistor according to the output voltage. A well terminal of the pass transistor is coupled to the second terminal of the first resistor for keeping the pass transistor turned off during electrostatic discharge through the pad.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a flash memory circuit.

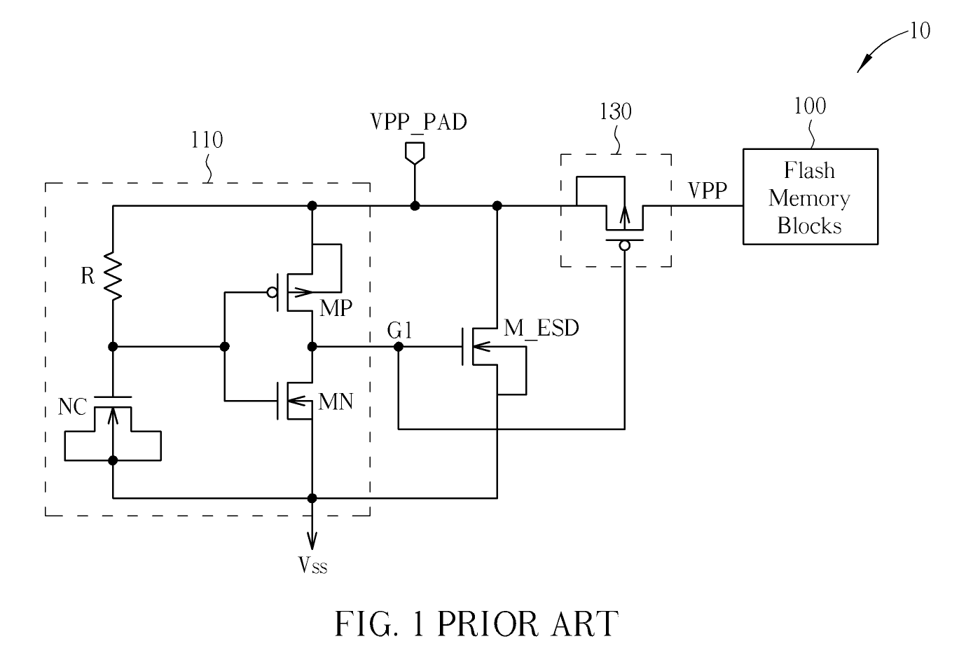

FIG. 2 is a diagram illustrating electrostatic discharge in the flash memory circuit of FIG. 1.

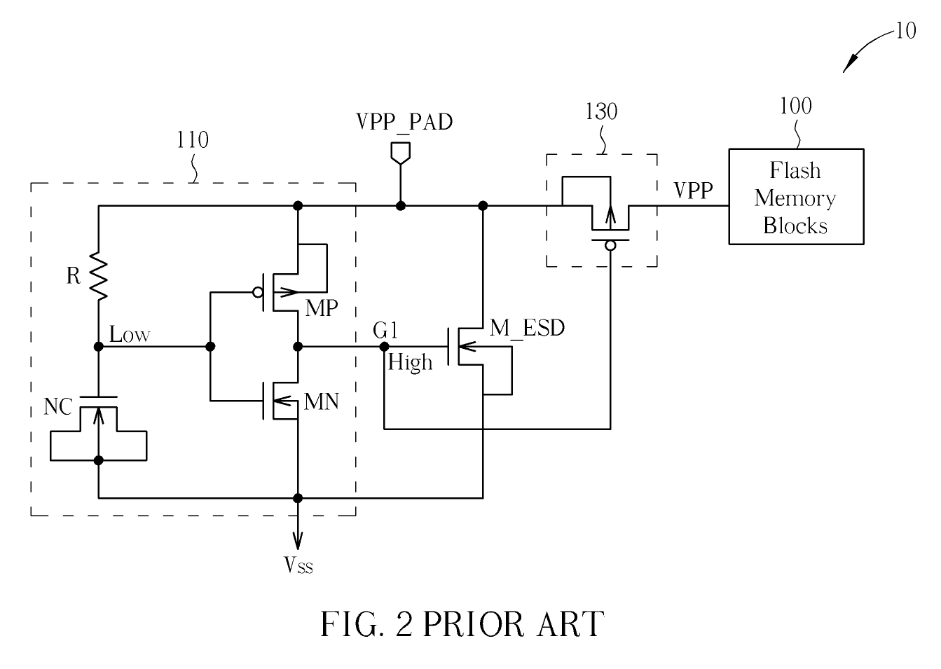

FIG. 3 is a diagram of a flash memory circuit with ESD protection according to a first embodiment.

FIG. 4 is a diagram of a flash memory circuit with ESD protection according to a second embodiment.

FIG. 5 is a diagram of a flash memory circuit with ESD protection according to a third embodiment.

### DETAILED DESCRIPTION

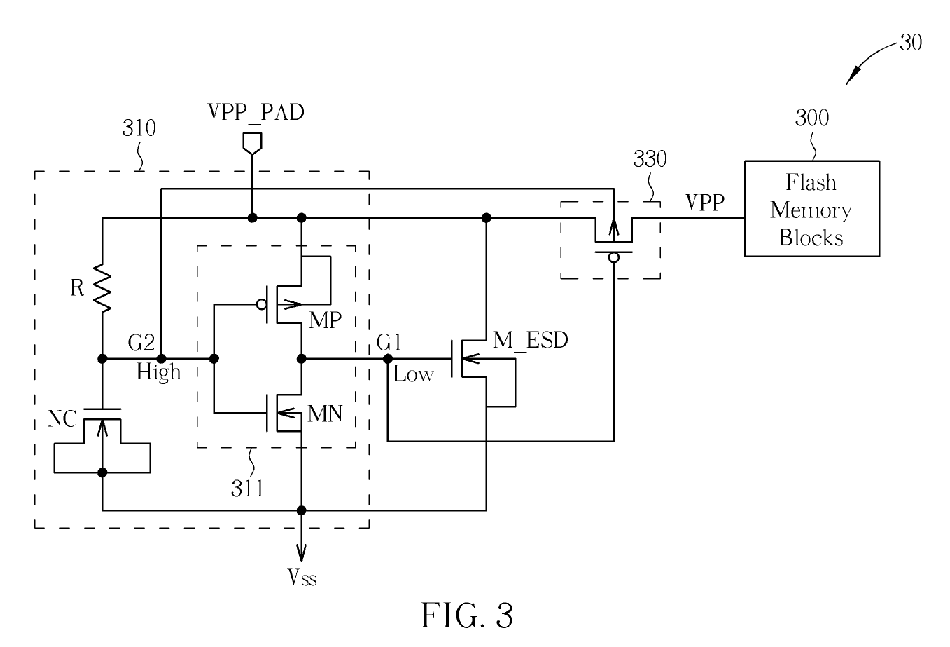

Please refer to FIG. 3, which is a diagram of a flash memory circuit 30 with ESD protection according to a first embodiment. The flash memory circuit 30 comprises a plurality of flash memory blocks 300, a pad VPP_PAD for receiving a pad voltage VPP, a gate driving circuit 310, an ESD transistor M_ESD, and a pass transistor 330. The gate driving circuit 310 comprises an inverter circuit 311, a resistor R, and a capacitor NC, such as a MOS capacitor. The inverter 311 comprises an input terminal at a node G2 for receiving a control voltage, and an output terminal at a node G1 for outputting an output voltage. The inverter circuit 311 inverts the control voltage to generate the output voltage. For example, if the voltage at node G2 is high, the voltage at node G1 may be low, or vise versa. The inverter 311 may comprise a first transistor MP, and a second transistor MN. The first transistor MP comprises a first terminal, e.g. a drain, a second terminal, e.g. a source, coupled to the pad VPP_PAD, and a control terminal, e.g. a gate. The control terminal is for controlling conduction of current from the first terminal of the first transistor to the second terminal of the first transistor according to the control voltage. The second transistor MN comprises a first terminal, e.g. a drain, coupled to the first terminal of the first transistor for outputting the output voltage, a second terminal, e.g. a source, coupled to the power supply VSS, and a control terminal, e.g. a gate, coupled to the control terminal of the first transistor. The control terminal of the second transistor MN is for controlling conduction of current from the first terminal of the second transistor MN to the second terminal of the second transistor MN according to the control voltage. The resistor R is for receiving the pad voltage VPP. A first terminal of the resistor R is coupled to the pad VPP_PAD for receiving the pad voltage VPP. A second terminal of the resistor R is coupled to the input terminal of the inverter circuit 311 at node G2. The capacitor NC is for delaying a change in the control voltage. A first terminal of the capacitor NC is coupled to the input terminal of the inverter circuit 311 at node G2. A second terminal of the capacitor NC is coupled to a power supply VSS, which may be a low voltage supply, or a ground. The ESD transistor M_ESD comprises a first terminal coupled to the pad VPP_PAD, a second terminal coupled to the power supply VSS, and a control terminal coupled to the output terminal of the inverter circuit at node G1 for receiving the output voltage. The control terminal of the ESD transistor M_ESD controls conduction of current from the first terminal of the ESD transistor M_ESD to the second terminal of the ESD transistor M_ESD according to the output voltage. The first terminal of the ESD transistor M_ESD may be a drain terminal, and the second terminal of the ESD transistor M_ESD may be a source terminal. The pass transistor 330 comprises a first terminal coupled to one of the flash memory blocks 300, a second terminal coupled to the pad VPP_PAD, and a control terminal coupled to the output terminal of the inverter circuit at node G1 for receiving the output voltage. The control terminal of the pass transistor 330 controls conduction of current from the first terminal of the pass transistor 330 to the second terminal of the pass transistor 330 according to the output voltage. The first terminal of the pass transistor 330 may be a drain terminal, and the second terminal of the pass transistor 330 may be a source terminal. A well terminal of the pass transistor 330 is coupled to the second terminal of the resistor R at node G2 for keeping the pass transistor 330 turned off during electrostatic discharge through the pad. The pass transistor 330 may be a PMOS transistor, and the ESD transistor M_ESD may be an NMOS transistor.

In the flash memory circuit 30 of FIG. 3, when ESD zapping occurs, ESD charges enter the flash memory circuit 30 through the pad VPP_PAD. The ESD charges are discharged through the ESD transistor M_ESD. When the ESD charges enter the flash memory circuit 30, the capacitor NC causes voltage at node G2 to be low due to voltage coupling, thus voltage at node G1 is high due to the inverter circuit 311. The high voltage level at node G1 causes the ESD transistor M_ESD to turn on, such that the ESD charges flow to the power supply VSS through the ESD transistor M_ESD. In the first embodiment, because the well terminal of the pass transistor 330 is coupled to the first terminal of the capacitor NC at node G2, and the voltage at node G2 is initially low, the pass transistor 330 will be fully shut off while the ESD transistor M_ESD directs the ESD charges to the power supply VSS. Thus, the path through the pass transistor 330 will be shut off, preventing the ESD charges from reaching the flash memory blocks 300.

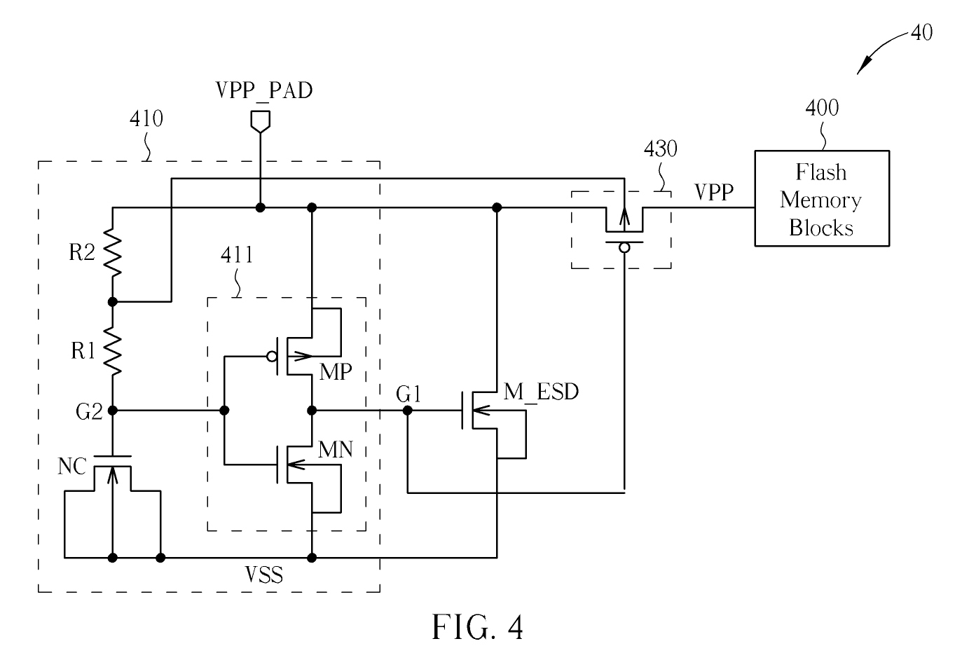

Please refer to FIG. 4, which is a diagram of a flash memory circuit 40 with ESD protection according to a second embodiment. The flash memory circuit 40 comprises a plurality of flash memory blocks 400, a pad VPP_PAD for receiving a pad voltage VPP, a gate driving circuit 410, an ESD transistor M_ESD, and a pass transistor 430. The gate driving circuit 410 comprises an inverter circuit 411, a first resistor R1, a second resistor R2, and a capacitor NC, such as a MOS capacitor. The inverter 411 comprises an input terminal at a node G2 for receiving a control voltage, and an output terminal at a node G1 for outputting an output voltage. The inverter circuit 411 inverts the control voltage to generate the output voltage. For example, if the voltage at node G2 is high, the voltage at node G1 may be low, or vise versa. The inverter 411 may comprise a first transistor MP, and a second transistor MN. The first transistor MP comprises a first terminal, e.g. a drain, a second terminal, e.g. a source, coupled to the pad VPP_PAD, and a control terminal, e.g. a gate. The control terminal is for controlling conduction of current from the first terminal of the first transistor to the second terminal of the first transistor according to the control voltage. The second transistor MN comprises a first terminal, e.g. a drain, coupled to the first terminal of the first transistor for outputting the output voltage, a second terminal, e.g. a source, coupled to the power supply VSS, and a control terminal, e.g. a gate, coupled to the control terminal of the first transistor. The control terminal of the second transistor MN is for controlling conduction of current from the first terminal of the second transistor MN to the second terminal of the second transistor MN according to the control voltage. The second resistor R2 is for receiving the pad voltage VPP. A first terminal of the second resistor R2 is coupled to the pad VPP_PAD for receiving the pad voltage VPP. A second terminal of the second resistor R2 is coupled to a first terminal of the first resistor R1. A second terminal of the first resistor is coupled to the input terminal of the inverter circuit 411 at node G2. In this embodiment, the first resistor R1 and the second resistor R2 are in series. The capacitor NC is for delaying a change in the control voltage. A first terminal of the capacitor NC is coupled to the input terminal of the inverter circuit at node G2. A second terminal of the capacitor NC is coupled to a power supply VSS, which may be a low voltage supply, or a ground. The ESD transistor M_ESD comprises a first terminal coupled to the pad VPP_PAD, a second terminal coupled to the power supply VSS, and a control terminal coupled to the output terminal of the inverter circuit at node G1 for receiving the output voltage. The control terminal of the ESD transistor M_ESD controls conduction of current from the first terminal of the ESD transistor M_ESD to the second terminal of the ESD transistor M_ESD according to the output voltage. The first terminal of the ESD transistor M_ESD may be a drain terminal, and the second terminal of the ESD transistor M_ESD may be a source terminal. The pass transistor 430 comprises a first terminal coupled to one of the flash memory blocks 400, a second terminal coupled to the pad VPP_PAD, and a control terminal coupled to the output terminal of the inverter circuit at node G1 for receiving the output voltage. The control terminal of the pass transistor 430 controls conduction of current from the first terminal of the pass transistor 430 to the second terminal of the pass transistor 430 according to the output voltage. The first terminal of the pass transistor 430 may be a drain terminal, and the second terminal of the pass transistor 430 may be a source terminal. A well terminal of the pass transistor 430 is coupled to the second terminal of the second resistor R2 for keeping the pass transistor 430 turned off during electrostatic discharge through the pad. The pass transistor 430 may be a PMOS transistor, and the ESD transistor M_ESD may be an NMOS transistor.

In operation of the flash memory circuits 30, 40 shown in FIG. 3 and FIG. 4, some ESD charges may travel through the second terminal of the pass transistor 330, 430 to the well terminal of the pass transistor 330, 430, and back to node G2. The ESD charges sent back to node G2 contribute to charging the capacitor NC, which may cause the output voltage of the inverter 311, 411 to turn on the pass transistor 330, 430 before all ESD charges have dissipated. To mitigate this effect, the well terminal of the pass transistor 430 is not directly coupled to node G2, but instead coupled to the node G2 through the second resistor R2, which delays the effect of the ESD charges sent back through the pass transistor 430, giving the ESD transistor M_ESD more time to dissipate the ESD charges to the power supply VSS.

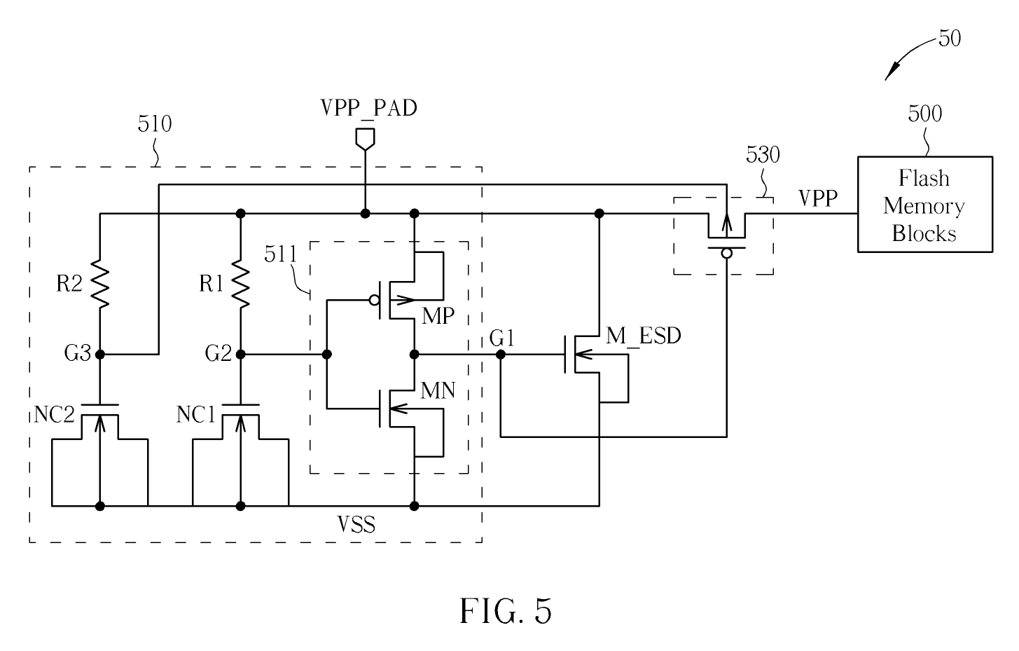

Please refer to FIG. 5, which is a diagram of a flash memory circuit 50 with ESD protection according to a third embodiment. The flash memory circuit 50 comprises a plurality of flash memory blocks 500, a pad VPP_PAD for receiving a pad voltage VPP, a gate driving circuit 510, an ESD transistor M_ESD, and a pass transistor 530. The gate driving circuit 510 comprises an inverter circuit 511, a first resistor R1, a second resistor R2, a first capacitor NC1, such as a MOS capacitor, and a second capacitor NC2, such as a MOS capacitor. The inverter 511 comprises an input terminal at a node G2 for receiving a control voltage, and an output terminal at a node G1 for outputting an output voltage. The inverter circuit 511 inverts the control voltage to generate the output voltage. For example, if the voltage at node G2 is high, the voltage at node G1 may be low, or vise versa. The inverter 511 may comprise a first transistor MP, and a second transistor MN. The first transistor MP comprises a first terminal, e.g. a drain, a second terminal, e.g. a source, coupled to the pad VPP_PAD, and a control terminal, e.g. a gate. The control terminal is for controlling conduction of current from the first terminal of the first transistor to the second terminal of the first transistor according to the control voltage. The second transistor MN comprises a first terminal, e.g. a drain, coupled to the first terminal of the first transistor for outputting the output voltage, a second terminal, e.g. a source, coupled to the power supply VSS, and a control terminal, e.g. a gate, coupled to the control terminal of the first transistor. The control terminal of the second transistor MN is for controlling conduction of current from the first terminal of the second transistor MN to the second terminal of the second transistor MN according to the control voltage. The first resistor R1 is for receiving the pad voltage VPP. A first terminal of the first resistor R1 is coupled to the pad VPP_PAD for receiving the pad voltage VPP. A second terminal of the first resistor R1 is coupled to the input terminal of the inverter circuit 511 at node G2. The first capacitor NC1 is for delaying a change in the control voltage. A first terminal of the first capacitor NC1 is coupled to the input terminal of the inverter circuit at node G2. A second terminal of the first capacitor NC1 is coupled to a power supply VSS, which may be a low voltage supply, or a ground. The ESD transistor M_ESD comprises a first terminal coupled to the pad VPP_PAD, a second terminal coupled to the power supply VSS, and a control terminal coupled to the output terminal of the inverter circuit at node G1 for receiving the output voltage. The control terminal of the ESD transistor M_ESD controls conduction of current from the first terminal of the ESD transistor M_ESD to the second terminal of the ESD transistor M_ESD according to the output voltage. The first terminal of the ESD transistor M_ESD may be a drain terminal, and the second terminal of the ESD transistor M_ESD may be a source terminal. The pass transistor 530 comprises a first terminal coupled to one of the flash memory blocks 500, a second terminal coupled to the pad VPP_PAD, and a control terminal coupled to the output terminal of the inverter circuit at node G1 for receiving the output voltage. The control terminal of the pass transistor 530 controls conduction of current from the first terminal of the pass transistor 530 to the second terminal of the pass transistor 530 according to the output voltage. The first terminal of the pass transistor 530 may be a drain terminal, and the second terminal of the pass transistor 530 may be a source terminal. The pass transistor 530 may be a PMOS transistor, and the ESD transistor M_ESD may be an NMOS transistor.

In the third embodiment, shown in FIG. 5, a well terminal of the pass transistor 530 is coupled at node G3 to an independent RC circuit comprising the second resistor R2 and the second capacitor NC2 for keeping the pass transistor 530 turned off during electrostatic discharge through the pad. The second resistor R2 is for receiving the pad voltage VPP. A first terminal of the second resistor R2 is coupled to the pad VPP_PAD, and a second terminal of the second resistor R2 outputs a well control voltage at node G3. The second capacitor NC2 is for delaying a change in the well control voltage. A first terminal of the second capacitor NC2 is coupled to the second terminal of the second resistor R2 at node G3, and a second terminal of the second capacitor NC2 is coupled to the power supply VSS. Unlike the first embodiment and the second embodiment, the flash memory circuit 50 utilizes the second resistor R2 and the second capacitor NC2 to control length of the voltage increase at the well terminal of the pass transistor 530. Thus, during ESD zapping, the pass transistor 530 may be completely off.

Compared to the prior art, in the embodiments of the present invention, the flash memory circuit 30, 40, 50 has a pass transistor 330, 430, 530 whose well terminal is coupled to node G2 or node G3 for keeping the pass transistor 330, 430, 530 fully off during ESD zapping. This provides better protection for the flash memory blocks 300, 400, 500.

Those skilled in the art will readily observe that numerous modifications and alterations of the device and method may be made while retaining the teachings of the invention.

What is claimed is:

1. A flash memory circuit comprising:
a plurality of flash memory blocks;
a pad for receiving a pad voltage;
a gate driving circuit comprising:
an inverter circuit having an input terminal for receiving a control voltage, and an output terminal for outputting an output voltage, the inverter circuit inverting the control voltage to generate the output voltage;
a resistor for receiving the pad voltage, the resistor comprising:
a first terminal coupled to the pad; and
a second terminal coupled to the input terminal of the inverter circuit; and
a capacitor for delaying a change in the control voltage, the capacitor comprising:
a first terminal coupled to the input terminal of the inverter circuit; and
a second terminal coupled to a power supply;
an ESD transistor comprising:
a first terminal coupled to the pad;
a second terminal coupled to the power supply; and
a control terminal coupled to the output terminal of the inverter circuit for receiving the output voltage, and controlling conduction of current from the first terminal of the ESD transistor to the second terminal of the ESD transistor according to the output voltage; and
a pass transistor comprising:
a first terminal coupled to one of the flash memory blocks;
a second terminal coupled to the pad;
a control terminal coupled to the output terminal of the inverter circuit for receiving the output voltage, and controlling conduction of current from the first terminal of the pass transistor to the second terminal of the pass transistor according to the output voltage; and
a well terminal coupled to the second terminal of the resistor for keeping the pass transistor turned off during electrostatic discharge through the pad.

2. The flash memory circuit of claim 1, wherein the pass transistor is a PMOS transistor, and the ESD transistor is an NMOS transistor.

3. The flash memory circuit of claim 1, wherein the inverter circuit comprises:
a first transistor comprising:
a first terminal;
a second terminal coupled to the pad; and
a control terminal for controlling conduction of current from the first terminal of the first transistor to the second terminal of the first transistor according to the control voltage; and
a second transistor comprising:
a first terminal coupled to the first terminal of the first transistor for outputting the output voltage;
a second terminal coupled to the power supply; and
a control terminal coupled to the control terminal of the first transistor for controlling conduction of current from the first terminal of the second transistor to the second terminal of the second transistor according to the control voltage.

4. A flash memory circuit comprising:
a plurality of flash memory blocks;
a pad for receiving a pad voltage;
a gate driving circuit comprising:
an inverter circuit having an input terminal for receiving a control voltage, and an output terminal for outputting an output voltage, the inverter circuit inverting the control voltage to generate the output voltage;
a first resistor for receiving the pad voltage, the first resistor comprising:
a first terminal coupled to the pad; and
a second terminal;
a second resistor comprising:
a first terminal coupled to the second terminal of the first resistor; and
a second terminal coupled to the input terminal of the inverter; and
a capacitor for delaying a change in the control voltage, the capacitor comprising:
a first terminal coupled to the input terminal of the inverter circuit; and
a second terminal coupled to a power supply;
an ESD transistor comprising:
a first terminal coupled to the pad;
a second terminal coupled to the power supply; and
a control terminal coupled to the output terminal of the inverter circuit for receiving the output voltage, and controlling conduction of current from the first terminal of the ESD transistor to the second terminal of the ESD transistor according to the output voltage; and
a pass transistor comprising:
a first terminal coupled to one of the flash memory blocks;
a second terminal coupled to the pad;
a control terminal coupled to the output terminal of the inverter circuit for receiving the output voltage, and controlling conduction of current from the first terminal of the pass transistor to the second terminal of the pass transistor according to the output voltage; and
a well terminal coupled to the second terminal of the first resistor for keeping the pass transistor turned off during electrostatic discharge through the pad.

5. The flash memory circuit of claim 4, wherein the pass transistor is a PMOS transistor, and the ESD transistor is an NMOS transistor.

6. The flash memory circuit of claim 4, wherein the inverter circuit comprises:
a first transistor comprising:
a first terminal;
a second terminal coupled to the pad; and
a control terminal for controlling conduction of current from the first terminal of the first transistor to the second terminal of the first transistor according to the control voltage; and
a second transistor comprising:
a first terminal coupled to the first terminal of the first transistor for outputting the output voltage;
a second terminal coupled to the power supply; and
a control terminal coupled to the control terminal of the first transistor for controlling conduction of current from the first terminal of the second transistor to the second terminal of the second transistor according to the control voltage.

7. A flash memory circuit comprising:
a plurality of flash memory blocks;
a pad for receiving a pad voltage;
a gate driving circuit comprising:
an inverter circuit having an input terminal for receiving a control voltage, and an output terminal for outputting an output voltage, the inverter circuit inverting the control voltage to generate the output voltage;
a first resistor for receiving the pad voltage, the first resistor comprising:
a first terminal coupled to the pad; and
a second terminal coupled to the input terminal of the inverter circuit;
a first capacitor for delaying a change in the control voltage, the first capacitor comprising:
a first terminal coupled to the input terminal of the inverter circuit; and
a second terminal coupled to a power supply;
a second resistor for receiving the pad voltage, the second resistor comprising:
a first terminal coupled to the pad; and
a second terminal for outputting a well control voltage;
a second capacitor for delaying a change in the well control voltage, the second capacitor comprising:
a first terminal coupled to the second terminal of the second resistor; and
a second terminal coupled to the power supply;
an ESD transistor comprising:
a first terminal coupled to the pad;
a second terminal coupled to the power supply; and
a control terminal coupled to the output terminal of the inverter circuit for receiving the output voltage, and controlling conduction of current from the first terminal of the ESD transistor to the second terminal of the ESD transistor according to the output voltage; and
a pass transistor comprising:
a first terminal coupled to one of the flash memory blocks;
a second terminal coupled to the pad;
a control terminal coupled to the output terminal of the inverter circuit for receiving the output voltage, and controlling conduction of current from the first terminal of the pass transistor to the second terminal of the pass transistor according to the output voltage; and
a well terminal coupled to the second terminal of the second resistor for receiving the well control voltage for keeping the pass transistor turned off during electrostatic discharge through the pad.

8. The flash memory circuit of claim 7, wherein the pass transistor is a PMOS transistor, and the ESD transistor is an NMOS transistor.

9. The flash memory circuit of claim 7, wherein the inverter circuit comprises:
a first transistor comprising:
a first terminal;
a second terminal coupled to the pad; and
a control terminal for controlling conduction of current from the first terminal of the first transistor to the second terminal of the first transistor according to the control voltage; and
a second transistor comprising:
a first terminal coupled to the first terminal of the first transistor for outputting the output voltage;
a second terminal coupled to the power supply; and
a control terminal coupled to the control terminal of the first transistor for controlling conduction of current from the first terminal of the second transistor to the second terminal of the second transistor according to the control voltage.
